(19) United States
(12) Patent Application Publication
(10) Pub. No.: US 2007/0214207 A1
(43) Pub. Date: Sep. 13, 2007

(54) Method and system for accurate issuance of data information

(76) Inventors: Fengzhou Xie, Beijing (CN); Dongxiao Li, Beijing (CN); Xu Guo, Beijing (CN); Huaxia Li, Beijing (CN); Lei Wang, Beijing (CN); Chenpu Hu, Beijing (CN); Gan Yu, Beijing (CN); Chenyang Xie, Beijing (CN)

Correspondence Address: DORSEY & WHITNEY LLP;INTELLECTUAL PROPERTY DEPARTMENT, 250 PARK AVENUE, NEW YORK, NY, 10177, US

(21) Appl. No.: 11/522,035

(22) Filed: Sep. 15, 2006

(30) Foreign Application Priority Data
Mar. 9, 2006 (CN) 200610057118.3

(51) Int. Cl. G06F 15/16

(52) U.S. Cl. 709/201; 709/203

(57) ABSTRACT

Exemplary embodiments of method and system can be provided for an accurate issuance of data information applied to a transmission of network data information, including: setting a client program; collecting relevant information of a user when the user uses the client program; deriving characteristic data of user from the relevant information of the user; determining a client of data information issuance according to the property of the data to be issued and the characteristic data of the user. Further, issuing the data information to the determined client. This invention can collect information via the client program, the relevant data of a user when the user uses the software, obtain the characteristic data of the user by arranging and inducing the data, and find the user suitable for certain advertisement delivery, thus the object of accurate advertisement delivery can be attained, transmission of the advertisement data information over network can be reduced, network resources can be saved and data transmission efficiency can be improved.

### CROSS-REFERENCE TO RELATED APPLICATION(S)

This application is based upon and claims the benefit of priority from Chinese Patent Application No. 200610057118.3, filed Mar. 9, 2006, under 35 U.S.C. § 119, the entire disclosure of which is incorporated herein by reference.

### FIELD OF THE INVENTION

The present invention generally relates to the field of data processing on a network, and more particularly, to a method and a system which is capable of providing accurate issuance of data information over the network, as well as to a method and a system in the field of an advertisement issuance, for accurate delivery of a digital media advertisement.

### BACKGROUND OF THE INVENTION

A certain type of information is intended to be transmitted over the network and to certain receivers. However, since the specific receiver which is intended to obtain the information may not be found correctly, a method of large-area information issuance has been generally and conventionally used to ensure that as many as possible of the receivers that are intended to receive the information can receive such information. Such conventional method of information issuance has the following shortcomings:

(a) the network resources for information transferring are significantly seriously wasted because a considerable part of the issued information is unnecessary;

(b) since a large number of the receivers receive the inappropriate and/or unneeded information, significant local system resources (e.g., memory resource, CPU resource, etc.) of the receivers, which otherwise do not have to be occupied, are considerably utilized to receive, decode and display the information and/or images associated therewith.

For example, a media advertisement issuance is a specific example of the above-described procedure of information issuance. Existing media include TV, broadcast, plane media, network media (portal website class and search class). Among them, TV, broadcast, plane media and portal website are short of individualized classifying analysis on the readers, listeners or viewers, and belong to a passive, static, forcibly-pushing advertisement issuance system without user-pertinence. In the process of such advertisement issuance, many resources need to be occupied, and the results of such advertisement activities are unsatisfactory, because there must be some people insensitive to the advertisement among those who receive the information. Transmitting advertisement information to these people firstly occupies considerable network resources (e.g., the network is needed to transfer the information), and secondly occupies some local computer resources of the receivers (e.g., the local computers are needed to decode and display the information).

To obviate the above-described problems and deficiencies associated with a waste of resources and improve the accuracy of the data transfer, a method for advertisement information issuance via a network media of search class has been used. However, the network media of search class is still a passive advertising system aiming only at key words, which can only reduce a part of void advertisement delivery, and can partially save resources. However, such system does not significantly obviate the problem of a waste of resources. In other words, currently there is still a problem of determining how to perform an accurate delivery in advertisement issuance via plane media, broadcast, TV, network media. In view of such situation, there is a need to determine how to learn who is interested in the advertisement information, how to deliver the advertisement to those interested in time, how to realize dynamic and intelligent delivery of a advertisement, how to realize real-time interaction between a sensitive user and the advertiser, and how to learn the details of the user's browsing of the advertisement.

### OBJECTS AND SUMMARY OF EXEMPLARY EMBODIMENTS OF THE INVENTION

To address and/or overcome the above-described problems and/or deficiencies, exemplary embodiments of the present invention provides a method and a system for accurate issuance of data information, by which network resources can be saved and utilized in a more effective manner, and the data transmission efficiency can be improved in the network data information transmission.

Another exemplary embodiment of the present invention provides a method and a system for accurate delivery of advertisement information by applying the above concept to advertisement issuance in the field of digital media (e.g., an e-magazine), by which the accuracy of advertising can be significantly improved.

To solve the above technical problems, exemplary embodiments of the present invention provide the following solutions.

A method for accurate issuance of data information, applied to transmission of network data information, comprising:

setting a client program;

collecting relevant information of a user when the user uses the client program;

deriving characteristic data of user from the relevant information of the user;

determining a client of data information issuance according to the property of the data to be issued and the characteristic data of user;

issuing the data information to the determined client.

An exemplary embodiment of the present invention also provides a system for accurate issuance of data information, applied to transmission of network data information, comprising:

a client module, for fulfilling a request of a client for use; collecting relevant information of the user; and transmitting the collected information to a user characteristic data analyzing module;

a user characteristic data analyzing module, for calculating characteristic data of user from the collected user information; and storing the collected user information and the characteristic data of user;

a data information issuance management module, for determining a client of data information issuance according to the property of the data to be issued and the characteristic data of user;

a data information issuance module which issues said data information to the determined client.

An exemplary embodiment of the present invention provides a method of accurate advertisement delivery used to deliver digital media advertisement information is also provided in the present invention, comprising:

setting a client program providing digital media browse;

collecting relevant information of a user when the user reads digital media using the client program;

deriving characteristic data of user from the relevant information of the user;

determining a client of advertisement delivery according to the property of the advertisement to be delivered and the characteristic data of user;

issuing the advertisement to the determined client.

Preferably, in an exemplary embodiment of the method of accurate advertisement delivery, a server may be provided for enabling a client program of one digital media to receive the advertisement information forwarded by a client program of another digital media. Preferably, in another exemplary embodiment of the method of accurate advertisement delivery, said server is also used to provide or illustrate the content information of the digital media, and provide a download link. Preferably, in another exemplary embodiment of the method of accurate advertisement delivery, the user may directly connect to the telephone of the advertiser via the client program of the digital media. Preferably, in another exemplary embodiment of the method of accurate advertisement delivery, the above-described method and system can dynamically issue corresponding advertisement information in real time according to the characteristic data of user at a certain point of time and/or according to the average characteristic data of user during a particular period of time. Preferably, another exemplary embodiment of the method of accurate advertisement delivery may also comprise collecting the information regarding the advertisement browse behavior of the user via a client program.

In a further exemplary embodiment of the present invention, a system to provide an accurate advertisement delivery for providing digital media advertisement information is provided, comprising:

a client module which display the content information of the digital media at the client; collect the relevant information regarding the user when the user utilizes the client program; and transmit the collected information to a user characteristic data analyzing module.

a user characteristic data analyzing module which calculating the characteristic data of the user according to the collected user information; and store the collected user information and the characteristic data of the user.

an advertisement information issuance management module which determine a client of advertisement information issuance according to the property of the advertisement to be delivered and the characteristic data of the user.

an advertisement information issuance module which issues said advertisement information to the determined client.

Preferably, an exemplary embodiment of the system of accurate advertisement delivery may also include a digital media content server, for displaying the content information of the digital media to a client and providing a download link. Another exemplary embodiment of the system can also include: a Peer-to-Peer (P2P) network server, for realizing digital content sharing among the client programs of the digital media, and/or a Voice over IP (VoIP) server for connecting to the telephone of the advertiser through the client program of the digital media. Another exemplary embodiment of the system may also include an advertisement feedback server, for collecting information on the advertisement browse behavior of the user at the client.

Exemplary embodiments of the system and method according to the present invention can collect the usage data of the user using the client software, obtain the characteristic data of the user through arranging and inducing the usage data, and determine a user group relatively suitable for certain advertisement delivery according to the style of the advertisement and the characteristic data of users. In this manner, the object of the accurate advertisement delivery can be attained, the transmission of the advertisement data information over network can be reduced, the network resources can be saved and data transmission efficiency can be improved; and the advertisement can be prevented from being received by the client that is not in need of the advertisement, so that processing of useless advertisement information at the client can be reduced and the resources of the local system can be saved.

In addition, exemplary embodiments of the system and method of the present invention can learn the time of the connection and magazine reading status of the user through client software, so that the real-time delivery of the advertisement can be realized. Thus, the probability of the advertisement being read can be increased, and the influence of the potential advertisement on the user can be improved. Moreover, the present invention can also dynamically issue the corresponding advertisement information in real time according to the characteristic data of the user at a certain point of time, so that the dynamic degree of the advertisement information can be improved.

An exemplary embodiment of the present invention can also collect the information on the advertisement browse behavior of the user at the client, for example, displaying time, being displayed in which kind of magazine, user identity information, and interactive information, etc., so that the effectiveness of the advertisement information issuance can be evaluated exactly and an accurate effectiveness feedback of the advertisement can be obtained.

According to further exemplary embodiments of the present invention, it may also be possible to adopt VoIP technique in the exemplary system and method, such that when the user reads the advertisement, he/she can connect to the customer service telephone of the advertiser by directly clicking on the telephone number for the advertised product, so that a real-time interaction between the user and the advertiser is realized. It is also possible to adopt P2P technique with the exemplary system and method to provide an advertisement transport among the users. For example, the user can recommend an advertisement he/she appreciates or finds interesting to his/her friend, and of course, it is required that the latter use the present invention as well. For the advertisement effectiveness, a suggestion from a friend may be very effective. In other words, an interpersonal direct communication may likely have a high influence. The recommendation function of the advertisement information provided according to the exemplary embodiments of the present invention can further improve the accuracy of the advertisement issuance.

### BRIEF DESCRIPTION OF THE DRAWINGS

Hereinafter the present invention will be described in detail with reference to embodiments and accompanying drawings, in which:

FIG. 1 is a schematic diagram illustrating exemplary procedures of a method for an accurate issuance of data information according to an exemplary embodiment of the present invention;

FIG. 2 is a schematic diagram illustrating the structure of a system for the accurate issuance of data information according to an embodiment of the present invention;

FIG. 3 is a framework diagram illustrating an intelligent decision support system according to one exemplary embodiment of the present invention;

FIG. 4 is a flow diagram for generating a user information source using an accurate advertisement delivery method according to an embodiment of the present invention;

FIG. 5 is a flow diagram for an acquisition of the sensitive data of user using an accurate advertisement delivery method according to an embodiment of the present invention;

FIG. 6 is a flow diagram for providing an intelligent decision of an advertisement issuance in an accurate advertisement delivery method according to an embodiment of the present invention; and

FIG. 7 is a schematic diagram illustrating the structure of an accurate advertisement delivery system according to an embodiment of the present invention.

Throughout the figures, the same reference numerals and characters, unless otherwise stated, are used to denote like features, elements, components or portions of the illustrated embodiments. Moreover, while the present invention will now be described in detail with reference to the figures, it is done so in connection with the illustrative exemplary embodiments.

### DETAILED DESCRIPTION OF THE PREFERRED EMBODIMENTS OF INVENTION

In general, for data information transmission over the network, it needs to consider the accuracy of data information issuance. For example, if the issuance of void information can be reduced to a large extent or as much as possible, a waste of resources can be reduced and information transmission efficiency can be improved. However, conventionally, the problem of how to obtain void advertisement information from all the advertisement information could not be solved, and thus the number of sensitive individuals who like to receive such advertisements could only be increased via a large-volume delivery. According to one exemplary embodiment of the present invention is: setting, the above-described problem can be addressed using a client program first, and appropriate user information can be obtained through the user's usage of the program. Further, the information to generate a specific data set of interest can be mined, and it is possible to determine which of the advertisements to be delivered to which of the clients according to the user data set and the advertisement information. In this manner, the match between an advertisement and the user can be improved, and the accuracy of the advertisement delivery can be increased.

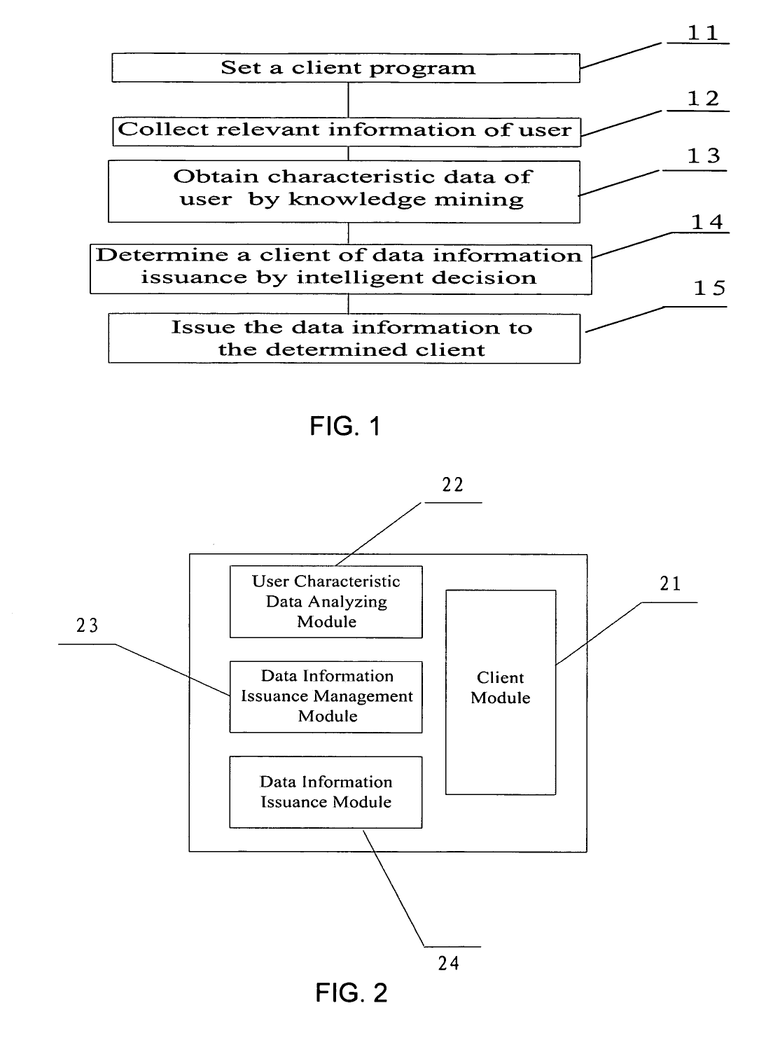

FIG. 1 shows a schematic diagram illustrating exemplary procedures of a method for an accurate issuance of information according to an exemplary embodiment of the present invention.

In step 11, a client program can be provided. To improve the accuracy of the data issuance, relevant information of a client need to be learned, so the relevant information of a user can be collected using such client program. The type of the client program which can be used may depend on the data information to be issued, and is not limited according to the present invention. According to one exemplary embodiment of the present invention, the client program can be applied to a Personal Computer (PC), a Personal Digital Assistant (PDA), a handhold device, a mobile terminal, a digital TV set, etc., a so that the relevant information of a user can be collected by all kinds of feasible means, and the application carrier of the client program is not further limited in the present invention.

In step 12, the relevant information of the user can be collected when the user utilizes the client program. The relevant information may include registration information for the user to use the client program, e.g., gender, age, etc. The relevant information may also include information regarding the procedure with which the user uses the client program, e.g., the time of use, the preference of use, etc.

In step 13, characteristic data of user can be derived from the relevant information of the user. After the data collection, an analysis performed on the collected user information. In existing means of data analysis, a database can provide the ability of management and simple processing of data. But simple query and maintenance provided by the database may not satisfy the demands of users, who prefer such data to be processed and analyzed for implementation at a higher level to obtain a prediction of overall property of the data and the development trends.

It is through setting calculation procedure that an exemplary embodiment of the present invention enables a computer to identify valid, novel, interesting and/or potentially useful data from a data set, and output finally comprehensible pattern of the data. The valid data varies with different demands, and different calculation procedures can be utilized according to different demands so that different data can be obtained.

Embodiments of the system and method according to the present invention can obtain characteristic data of user from the collected information using a procedure of Knowledge Mining. The Knowledge Mining can be regarded as searching or generating a specific pattern of interest or a specific data set. The Knowledge Discovery has been implemented in a limited manner in convention databases. In general, the Knowledge Discovery in databases can be regarded as a procedure for discovering useful knowledge from data and other information. According the Knowledge Discovery concepts in databases will not be described in detail herein as such concepts are known by those having ordinary skill in the art.

There are certain introductions of Knowledge Discovery in Data Base in the prior art. In general, Knowledge Discovery in Data Base is regarded as a whole procedure of discovering useful knowledge from data and information. Knowledge Discovery in Data Base will not be described in detail in the present invention, and reference can be made to related patent application documents to obtain detailed information.

Knowledge Mining is a technique for implementing Knowledge Discovery in databases. This exemplary procedure can be a series of techniques and applications and/or a method set for investigating and modeling high-volume data and relationship between the data; it is a procedure of extracting implicit, formerly unknown information with a potential application value from the database, the object of which may be to transform the high-volume data into useful knowledge and information. Knowledge Mining is the core of Knowledge Discovery in Databases (KDD). Knowledge Mining technique serves to transform implicit knowledge into the explicit knowledge. Knowledge Mining technique and Data Mining technique may have many common features. However, the Knowledge Mining technique has higher requirements on the results and can be more valuable, and in general, Knowledge Mining aims at some specific databases and knowledge bases.

The Knowledge Mining techniques can implement information mining adopting a method of question inference, e.g., search for a task solution model, search the collected user information and select an inference method in a method base, so as to obtain aided decision knowledge information through decision inference, and at last, express the obtained knowledge information with a specific pattern. The Knowledge Mining techniques can also implement certain information mining procedures adopting an exemplary method to obtain a question solution, e.g., search for a task solution model, select an inference method or another mining procedure from the knowledge base according to the procedure adopted by the model to obtain aided decision knowledge information, and express such obtained aided decision knowledge information with a specific pattern.

In step 14, a determination of a client of the data information issuance can be made according to the property of the data to be issued and the characteristic data of the user. Actually, this step can be regarded as a procedure of computer aided decision. The procedure of aided decision may be evaluating through collecting the information input by a user via a man-machine interactive interface or evaluating by utilizing all kinds of aided tools (e.g., analytic tools for various graphics and so on), so as to obtain certain information regarding which of the clients are suitable for data information issuance, so that the ratio of issuing the void data information will be lower. The procedure of the aided decision can be an automatic evaluation method based on causal rules of a self-cognition logic that the computer may preset, e.g., the procedure of aided decision can be implemented automatically by the computer according to association degree of the rules and the set threshold value.

In step 15 the information can be issued or provided to the determined client. The client can receives the data information issued by the server, and the whole procedure of data information issuance is completed. The data information can be shared between two client programs. The server can dynamically issue the corresponding advertisement information in real time according to the characteristic data of the user at a certain point of time; and the server can also issue the corresponding advertisement information in real time according to the average characteristic data of user in a period of time.

With reference to FIG. 2, there is shown a schematic diagram illustrating the structure of a system for accurate issuance of data information according to an embodiment of the present invention, applied to transmission of network information data; the system includes the following components:

A client module 21 for fulfilling a request of a client for use; collecting relevant information of a user when the user uses the client program; and transmitting the collected information to a user characteristic data analyzing module. Different user information can be collected on different client applications, so that it is helpful to collect more user information, and analyze such information to obtain more characteristic data of the user.

A user characteristic data analyzing module 22, for calculating the characteristic data of the user according to the collected user information; and storing the collected user information and the characteristic data of the user. The user characteristic data analyzing module is actually a system for knowledge mining, which is a series of techniques and applications or a method set of investigating and modeling high-volume data and relationship between the data, which is a procedure of extracting implicit, formerly undiscovered information with potential application value from a database, and the object of which is to transform the high-volume data into useful knowledge and information.

A data information issuance management module 23, for determining a client of data information issuance according to the property of the data to be issued and the characteristic data of the user. The data information issuance management module 23 may actually be an intelligent decision support system. An intelligent decision support system is generally regarded as an aided decision system combining Artificial Intelligence (AI) and DSS, utilizing an Expert System (ES) to enable the DSS to utilize human knowledge, such as description knowledge about decision issues, process knowledge for decision procedures and inference knowledge for solving problems more adequately, and helping in solving complicated decision issues through a logic inference.

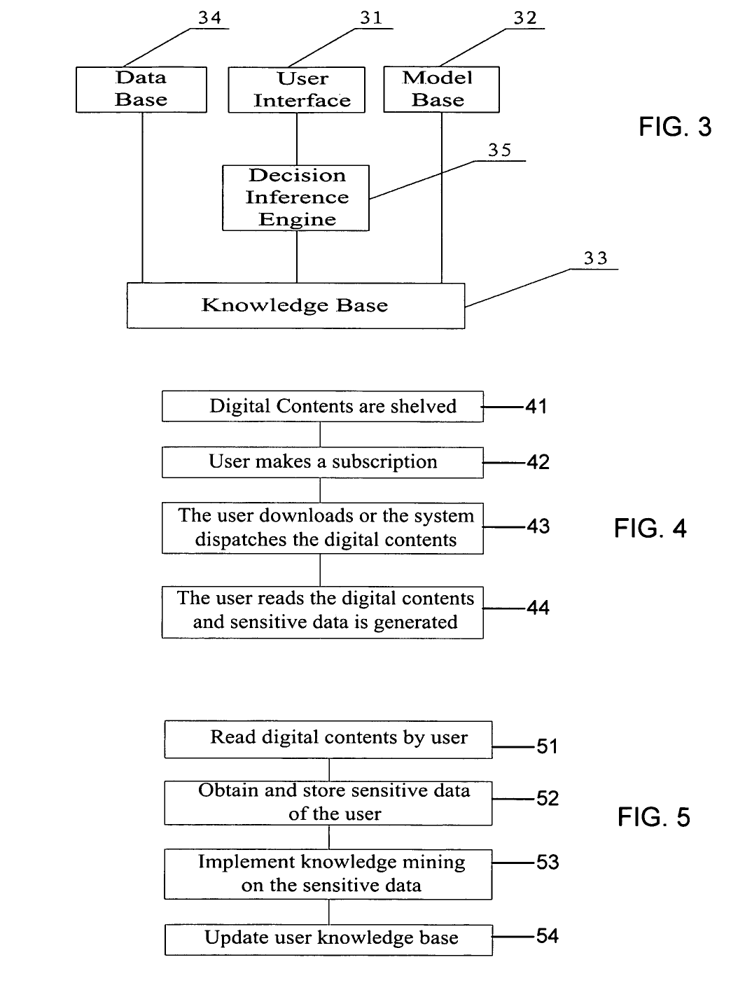

FIG. 3 shows a framework diagram illustrating an intelligent decision support system, which includes the following components:

A user interface 31, i.e. an interface for input and output, which is a window for man-machine interaction.

A model base 32. A model base should have functions of storage and dynamic modeling; model management is implemented by a model base system. The model base can store basic models for inference and solution according to different users' demands or questions.

A knowledge base 33, which implements centralized management of the knowledge (e.g., rules and facts) regarding the field of decision issues, comprising the functions of acquisition, expression, management, etc. of knowledge. The knowledge management is implemented through a knowledge base system.

A data base 34, which manages and stores the data regarding the field of decision issues.

An inference engine 35, which identifies and solves problems, and which can be divided into two types: deterministic inference and nondeterministic inference.

The system for accurate issuance of data information as show in FIG. 2 may also include a data information issuance module 24, for issuing the data information to the determined client.

Hereinafter the above concept will be applied to advertisement issuance via a digital media (e.g., an e-magazine) and an embodiment according to the method for accurate delivery of advertisement information will be described in detail. In such description, the characteristic data of the user is substituted by a term “sensitive data” in the field of the advertisement issuance. The client program in an exemplary embodiment of the present invention adopts a form of the digital media, preferably, an e-magazine, to collect sensitive data such as reading time, reading contents, etc. of the user.

The digital media is a carrier of the digital content, for example, e-magazine, audio/video stream media, etc. The digital contents can include, but not limited to, contents that can be digitalized, such as digital games, computer animations, digital learning, digital video and audio, mobile contents, network services, content software, digital publication, etc. For the sake of simplicity, hereinafter the exemplary embodiment of the present invention will be described by adopting “e-magazine” instead of “digital media”.

Before digital contents are issued through the present system, the digital contents can be classified in terms of its type, for example, entertainment, travel, car, etc. Further; the contents of each page in the magazine can be sub-classified into, for example, introduction of luxury car, introduction of economical car, etc., and the classification information is written in the information reserve position of the magazine by a magazine shelving system. When the user reads the magazine, the classification and sub-classification of the magazine will be reported to a background server, so that the taste and interest of the user can be learned and original sensitive data of the user is generated.

Classification and sub-classification of the digital content can be implemented through pre-definition and input into the data base through a program; when the digital content is to be issued on-line issued, it just needs to select the type of the contents and the sub-type of the contents of each page.

FIG. 4 shows a flow diagram for generating a user information source using an accurate advertisement delivery method according to an exemplary embodiment of the present invention. After being classified as described herein above, the digital content can be issued on-line, and the user can look over and browse the content summary of the e-magazine. After reading, the user can subscribe to the required e-magazine and downloads the e-magazine to the user's local computer, or the server can also issue (dispatch) the content of the e-magazine directly. In a word, after this step, the user can browse the contents of the e-magazine through the local computer, so that a data source for user information acquisition is formed. A client program collects relevant information of the user when the user read the e-magazine through the client program.

The user knowledge (e.g., the user information) can be divided into an explicit knowledge and an implicit knowledge. The explicit Knowledge may include registration information such as gender, age, and province, which is obtained when a user registers and can just be updated in the user knowledge base directly. The implicit knowledge may include discrete and random knowledge data such as reading taste, reading habit, on-line time, which can be obtained when a user selects, subscribes, downloads and reads the digital contents. That is to say, the digital contents downloaded by the user are an implicit knowledge source of the user.

FIG. 5 shows a flow diagram for an acquisition of the sensitive data of user using the accurate advertisement delivery method according to an exemplary embodiment of the present invention. When the user reads digital contents, implicit knowledge of the user may be generated. The discrete and random implicit knowledge of the user is collected through a knowledge acquisition process (e.g., an information collection process), and stored in a background data warehouse. After the implicit knowledge is stored in the data warehouse, the user knowledge base will be updated through Knowledge Mining, and the generation of the sensitive knowledge of user is completed.

With an example of the user reading a certain car magazine through the client software according to one exemplary embodiment of the present invention, when the user reads the magazine, the client software will record at what time the user read the car magazine, which part of the magazine the user read, e.g., the luxury car part or the economical car part, and how long did the user read this part, and report these data to the background data warehouse. Similarly, the user may possibly read a certain travel magazine, and the exemplary system data warehouse can record the user's behavior regarding such review of the travel magazine. In addition, the client software may also report the on-line time, etc. to the background system data warehouse. Thus, the system data warehouse can store the characteristic data of the user, such as a large amount of the reading behavior information of the user, using habits of the user, e.g., on-lime time, etc.

When the user knowledge base is being updated, the knowledge mining system mines such large amount of the user reading behavior data and provides a different weight to the classifications of the user's interest according to the reading time thereof. For example, if the user spends 60% of time to read the car magazine and 30% of time to read the travel magazine, the exemplary data mining system will classify the user as a primary car-sensitive user and a secondary travel-sensitive user. At that time, the exemplary knowledge mining system also mines the data regarding the using habit of the user, obtains the using characteristic data of the user, e.g., daily on-line time and stores them in the user knowledge base. The knowledge on sensitive classification weight value and the on-line time of the user is stored in the user knowledge base and updated dynamically.

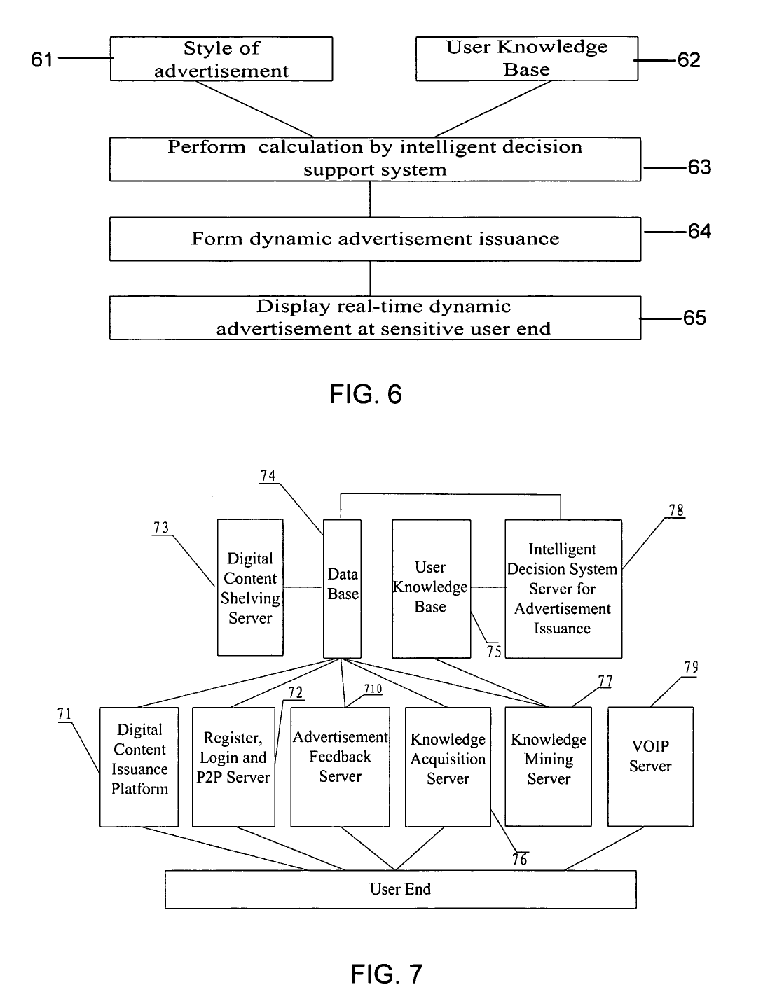

FIG. 6 shows a flow diagram for providing an intelligent decision of an advertisement issuance using the advertisement delivery method according to a further exemplary embodiment of the present invention. When an advertiser needs to issue an advertisement on a digital content issuance platform, the advertisement issuance intelligent decision support system can form an issuance strategy for the advertisement according to the style of the advertised product and the sensitive data of user stored in the user knowledge base and through a model inference procedure in the intelligent decision support system, i.e., can determine a group of user ends more sensitive to the advertised product, and thus can intelligently dispatch the advertisement to the users sensitive to this type of product; moreover, multiple dispatch strategies can be assigned for dispatch of the advertisement, and finally, real-time and dynamic advertisement can be presented at the sensitive user end.

Using one example, a car advertisement can be dispatched to the primary car-sensitive user or to both the primary car-sensitive user and the secondary car-sensitive user according to the demand of the advertiser. The time of dispatch can be intelligently and automatically provided according to the time of connecting of the user to ensure a maximal real-time dispatch success ratio. An exemplary embodiment of the system according to the present invention can also support a situational real-time advertisement issuance strategy. For example, if a certain user is reading a certain kind of magazine, e.g. a car magazine, the client software will report to the background server in real time, and after obtaining the classification information of the magazine, the user can read such magazine on-line, and the exemplary background system will automatically insert a car advertisement during the reading process. Since all the advertisements aim at the network users using the client program according to an exemplary embodiment of the present invention, the advertisement delivery is real-time and dynamic.

According to one exemplary embodiment of the present invention, when the user reads the advertisement using the exemplary client program, by the use of voice over Internet Protocol (VoIP) technique(s), the user can connect with the customer service telephone of the advertiser just by directly clicking on the telephone number for the advertised product so that real-time interaction between the user and the advertiser can be obtained. In another exemplary embodiment of the present invention, using a P2P technique, the user can recommend an advertisement he/she appreciates to his/her friend, and it is required that the latter can and should utilize the exemplary embodiment of the client program according to the present invention as well, so that sharing of the information can be realized.

As know to those having ordinary skill in the art, P2P technique is a type of a Peer-to-Peer network communication technique which provides end-to-end and mutual Client/Server communication, in contrast to a traditional Client/Server architecture. According to a further exemplary embodiment of the present invention, the user can recommend a particular advertisement that he/she has used to his/her friend via the P2P technique, so that the effect of the advertisement can be improved. In general, P2P technique has the following technical characteristics: the user end can be a server or a client program according to the demand of the user, and the network application can be freely driven by the user; the information flows directly among network devices, at a high speed and in time, so that the cost of transfer service can be decreased; it constructs the basis and application of a network device interaction while spreading the network information, P2P devices with the same characteristics can compose a subnet present in the large net of the Internet to centralize the information over again in a new way.

The accurate advertisement delivery method according to an embodiment of the present invention described above can realize accurate delivery of the advertisement information, but cannot learn a user's browse status of the advertisement information after the advertisement information has been delivered to the client. Thus, to obtain an accurate feedback information after the advertisement information has been delivered, the exemplary embodiment of the accurate advertisement delivery method according to an embodiment of the present invention described above can also include the following procedures. For example, a collection of relevant information can be performed. Such relevant information can include a display of time the advertisement information has been provided at the client, the display of particular type of a magazine, user identity information and interactive information between the user and the advertisement, etc. The above exemplary information is provided back to the data warehouse and is statistically analyzed, so as to evaluate the effect of the advertisement information issuance accurately, and obtain an accurate feedback of the advertisement effect. According to an exemplary embodiment of the present invention, since the relevant information on the advertisement display can be collected via the network, the real-time feedback of the advertisement effect can also be realized. The relevant information on the advertisement display may include, but not limited to, displaying time, displayed the type of the magazine, user identity information and interactive information between the user and the advertisement, etc. The interactive information between the user and the advertisement may include, but not limited to, the behavior information on the user's clicking on the telephone number of the advertisement, on the user's recommendation of the advertisement to other users, etc.

An exemplary embodiment of the accurate advertisement delivery system for digital media advertisement delivery according to the present invention, which includes the following components:

A client module which can display the content information of the digital media at the client, collect relevant information associated with the user when the user uses the client program, and transmit the collected information to the user characteristic data analyzing module (described below);

A user characteristic data analyzing module which calculate the characteristic data of user from the collected user information, and store the collected user information and the characteristic data of user;

An advertisement information issuance management module which determines a client of the advertisement information issuance according to the property of the advertisement to be issued and the characteristic data of the user.

An advertisement information issuance module which issue the advertisement information to the determined client.

FIG. 7 shows a schematic diagram of an exemplary structure of an accurate advertisement delivery system according to an exemplary embodiment of the present invention, which includes the following components:

A digital content issuance platform 71 which can provide the functionality such as interaction between the user and a digital media web site, digital content subscription and download, etc. It is equivalent to a digital media content server used to show the content information of the digital media to the client and provide a download link.

A register, login and p2p server 72 which can provide the functionality such as user registration, user login, P2P digital content sharing and P2P digital content download, which can realize digital content sharing among the client programs of the digital media.

A digital content shelving server 73 which can add the digital contents provided by the digital content provider to the digital content issuance platform 71.

A data warehouse 74 which can be provided for storing all kinds of background data.

A user knowledge base 75 which can store the knowledge regarding the user, including the explicit knowledge (e.g., user registration information) and the implicit knowledge, where the implicit knowledge refers to the knowledge regarding the user taste obtained by the analysis from the implicit data, such as reading behavior of the user.

A knowledge acquisition server 76 which collect implicit data, such as reading behavior and on-line time of the user, and store them in the data warehouse 74. The relevant information of the user in the process of browsing digital media is collected mainly through the register, login and p2p server 72 and the knowledge acquisition server 76.

A knowledge mining server 77 which extract the implicit and unpredictable classification knowledge of a sensitive user, such as the user's taste, from the plentiful, incomplete, fuzzy and random data, such as the user's reading behavior, and storing the knowledge into the user knowledge base 75. The function of user characteristic data analyzing module described above can be implemented through the knowledge mining server 77.

An advertisement issuance intelligent decision system server 78 according to the characteristics of the customer's product advertisement, implementing an intelligent decision based on the user knowledge base 75, and dynamically dispatching an advertisement to the sensitive user. The advertisement issuance intelligent decision system server 78 is equivalent to the advertisement information issuance management module described above, which is used to provide an advertisement issuance strategy and determine the client of the advertisement information issuance.

A VoIP server 79 which provide service for real-time PC-Phone interaction of the VoIP telephone between the system user and the advertiser.

The exemplary embodiment of the accurate advertisement delivery system according to the present invention described above can now realize an accurate delivery of the advertisement information, but cannot learn a user's browse status of the advertisement information after the advertisement has been delivered to the client. To obtain accurate feedback information after the advertisement information has been delivered, the accurate advertisement delivery system according to one exemplary embodiment of the present invention described above may also include an advertisement feedback server 710, for collecting relevant information on the user's behavior of browsing advertisement at the client. The above information is fed back to the data warehouse 74 and statistically analyzed, so as to evaluate the effect of the advertisement information issuance accurately, and obtain an accurate feedback of the advertisement effect. According to one exemplary embodiment of the present invention, since the relevant information on the advertisement display is collected via the network, a real-time feedback of the advertisement effect can also be realized. The relevant information on the advertisement display may include, but not limited to, providing the displaying time, the type of the magazine, user identity information and interactive information between the user and the advertisement, etc.

The foregoing merely illustrates the principles of the invention. A method and a system for accurate issuance of data information over network according to exemplary embodiments of the present invention, as well as a method and a system for accurate delivery of digital media advertisement applied to the field of advertisement issuance according to exemplary embodiments of the present invention have been described above in detail. Specific exemplary embodiments are used to illustrate the principle and implementation method of the present invention, and only used to understand the method and the core idea of the present invention. At the same time, various changes may be made to the embodiments and the applications thereof by those skilled in the art within the scope of the present invention. Various modifications and alterations to the described embodiments will be apparent to those skilled in the art in view of the teachings herein. It will thus be appreciated that those skilled in the art will be able to devise numerous systems, arrangements and methods which, although not explicitly shown or described herein, embody the principles of the invention and are thus within the spirit and scope of the present invention. In addition, to the extent that the prior art knowledge has not been explicitly incorporated by reference herein above, it is explicitly being incorporated herein in its entirety. All publications referenced herein above are incorporated herein by reference in their entireties.

What is claimed is:

1. A method for accurate issuance of data information, applied to transmission of network data information, comprising:
setting a client program;
collecting relevant information associated with a user when the user uses the client program; deriving characteristic data of user from the relevant information of the user;
determining a client of data information issuance according to the property of the data to be issued and the characteristic data of the user;
issuing the data information to the determined client.

2. A system for accurate issuance of data information, applied to transmission of network data information, comprising:
a client module, for fulfilling a request of a client for use; collecting relevant information of the user; and transmitting the collected information to a user characteristic data analyzing module;
a user characteristic data analyzing module, for calculating characteristic data of user from the collected user information; and storing the collected user information and the characteristic data of user;
a data information issuance management module, for determining a client of data information issuance according to the property of the data to be issued and the characteristic data of the user;
a data information issuance module which issues said data information to the determined client.

3. A method of accurate advertisement delivery used to deliver digital media advertisement information, comprising:
setting a client program providing digital media browse;
collecting relevant information associated with a user when the user reads the digital media using the client program;
deriving characteristic data of user from the relevant information of the user;
determining a client of advertisement delivery according to the property of the advertisement to be delivered information and the characteristic data of the user;
issuing the advertisement to the determined client.

4. The method according to claim 3, further comprising a server showing the content information of the digital media and providing a download link associated with the content information.

5. The method according to claim 3, further comprising a client program of one digital media receiving the advertisement information forwarded by a client program of another digital media.

6. The method according to claim 3, further comprising directly connecting the user to a telephonic arrangement of an advertiser associated with the advertisement information via the digital media.

7. The method according to claim 3, further comprising dynamically issuing corresponding advertisement information in real time according to the characteristic data of the user at a certain point of time.

8. The method according to claim 3, further comprising issuing corresponding advertisement information in real time according to the average characteristic data of user during a period of time.

9. The method according to claim 3, further comprising collecting the information on the advertisement browse behavior of the user via the client program.

10. A system of accurate advertisement delivery used to deliver digital media advertisement information, comprising:
a client module, for displaying the content information of the digital media at a client;
collecting relevant information associated with the user when the user uses the client program; and
transmitting the collected information to a user characteristic data analyzing module;
a user characteristic data analyzing module, for calculating the characteristic data of the user according to the collected user information; and storing the collected user information and the characteristic data of user;
an advertisement information issuance management module, for determining a client of advertisement information issuance according to the property of the advertisement to be delivered and the characteristic data of user;
an advertisement information issuance module which issues said advertisement information to the determined client.

11. The system according to claim 10, further comprising a digital media content server, for displaying the content information of the digital media to the client, and providing a download link associated with the content information.

12. The system according to claim 10, further comprising a Peer-to-Peer (P2P) network server, for realizing digital content sharing among the client programs of digital media.

13. The system according to claim 10, further comprising a Voice over IP (VoIP) server, for connecting to a telephone arrangement of an advertiser associated with the advertising information via the client program of the digital media.

14. The system according to claim 10, further comprising an advertisement feedback server, for collecting information on the advertisement browse behavior of the user via the client program.
